(19) United States
(12) Patent Application Publication
(10) Pub. No.: US 2024/0399489 A1
(43) Pub. Date: Dec. 5, 2024

(54) THERMAL ASSISTED SELF-PIERCING RIVETING FOR HIGH STRENGTH 7XXX ALUMINUM

(71) Applicant: Novelis Inc., Atlanta, GA (US)

(72) Inventors: Feng Wu, Shanghai (CN); Kevin Duan, Shanghai (CN); Ming Gan, Shanghai (CN); Yan Lin, Shanghai (CN); Yu Guo, Shanghai (CN)

(73) Assignee: Novelis Inc., Atlanta, GA (US)

(21) Appl. No.: 18/698,239

(22) PCT Filed: Oct. 13, 2022
(86) PCT No.: PCT/CN2022/125161

§ 371 Date: Apr. 3, 2024

Related U.S. Application Data
(60) Provisional application No. 63/262,761, filed on Oct. 20, 2021.

(51) Int. Cl. B23K 11/18; B21J 15/02; B23K 11/11; B23K 103/10; F16B 5/04

(52) U.S. Cl. CPC B23K 11/185; B21J 15/025; B23K 11/11; F16B 5/04; B23K 2103/10

(57) ABSTRACT

A self-piercing riveting system includes a localized melting system that locally melts a target location on a metal substrate and a driver that drives a rivet into to the metal substrate after the target location is locally melted. A method of forming a joint with a self-piercing riveting system includes locally melting a target location on the at least two metal substrates. The method also includes driving a rivet into the target location, optionally with a driver, after locally melting the target location such that the rivet pierces the at least two metal substrates at the target location.

### REFERENCE TO RELATED APPLICATION

This application claims the benefit of U.S. Provisional Patent Application No. 63/262,761, filed on Oct. 20, 2021 and entitled THERMAL ASSISTED SELF-PIERCING RIVETING FOR HIGH STRENGTH 7XXX ALUMINUM, the content of which is hereby incorporated by reference in its entirety.

### FIELD OF THE INVENTION

This application relates to self-piercing riveting systems and methods, and, more particularly, to self-piercing riveting systems and methods for high strength aluminum alloys.

### BACKGROUND

Various joining techniques may be used to join components together to form various parts or components of a final product. Such joining techniques may include various types of welding (e.g., resistance spot welding, friction stir welding, laser beam welding, ultrasonic welding, etc.), adhesives, and/or mechanical fastening, among others.

Self-piercing riveting is a type of mechanical fastening technique that uses a rivet, which typically has a head and a base. During a self-piercing riveting process, the rivet is driven by a driver into one or more sheets such that the base of the rivet passes through at least one sheet and deforms to form a mechanical interlock. A problem with traditional self-piercing riveting processes is that in high strength materials, such as high strength aluminum alloys, cracking may occur in one or both of the sheets or components joined by the rivet (such cracking is sometimes known as a “button crack”). Such cracking may result in premature failure of the self-piercing riveting joint, and may be entirely unacceptable in certain industries such as the automotive industry or aerospace industry, among others.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a self-piercing riveting system includes a localized melting system and a driver. The localized melting system may locally melt a target location on a metal substrate. In one non-limiting embodiment, the localized melting system is a resistance spot welding system. The driver may drive a rivet into the metal substrate at the target location after the target location has been locally melted. The rivet driven into the metal substrate forms a joint.

According to some embodiments, a method of joining at least two metal substrates includes locally melting a target location on the at least two metal substrates. The method includes driving a rivet into the target location with a driver after locally melting the target location such that the rivet pierces the at least two metal substrates at the target location.

According to various embodiments, a method of joining at least two metal substrates includes welding the at least two substrates at a target location for a welding time of greater than 0 seconds and less than 1 second and such that a temperature of the target location is at least 500° C. The method includes driving a rivet into the target location after welding such that the rivet pierces the at least two metal substrates at the target location.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a self-piercing riveting system according to embodiments.

FIG. 2A illustrates metal substrates during a preheating stage of a joining process with a self-piercing riveting system according to embodiments.

FIG. 2B illustrates the metal substrates of FIG. 2A during a riveting stage of the joining process.

FIGS. 3A-B illustrate a joint formed with a self-piercing riveting system according to embodiments.

FIGS. 4A-B illustrate a traditional joint formed in two metal substrates.

FIGS. 4C-D illustrate a joint formed with a self-piercing riveting system according to embodiments in the metal substrates of FIGS. 4A-B.

FIGS. SA-B illustrate a traditional joint formed in two metal substrates.

FIGS. SC-D illustrate a joint formed with a self-piercing riveting system according to embodiments in the metal substrates of FIGS. 5A-B.

FIGS. 6A-B illustrate a traditional joint formed in two metal substrates.

FIGS. 6C-D illustrate a joint formed with a self-piercing riveting system according to embodiments in the metal substrates of FIGS. 6A-B.

FIGS. 7A-B illustrate a traditional joint formed in two metal substrates.

FIGS. 7C-D illustrate a joint formed with a self-piercing riveting system according to embodiments in the metal substrates of FIGS. 7A-B.

FIG. 8 is a table of results for traditional joints and joints formed with a self-piercing riveting system according to embodiments.

FIG. 9 illustrates a target location formed by two metal substrates wherein the interface of the target location is partially melted according to embodiments.

FIGS. 10A-B illustrate a traditional joint formed in two metal substrates.

FIGS. 10C-D illustrate a joint formed with a self-piercing riveting system according to embodiments in the metal substrates of FIGS. 10A-B.

### DETAILED DESCRIPTION

Described herein are self-piercing riveting (SPR) systems and associated methods for joining two or more metal substrates. The SPR systems provided herein include a pre-heating system that locally melts a target location on the metal substrates, and a driver that drives a rivet into the target location on the metal substrates to form a joint that joins the metal substrates. As used herein, locally melting the target location before a SPR process refers to heating without apparent material welding of the substrates. In certain embodiments, the interface at the target location between the metal substrates may be entirely locally melted (e.g., the entire target area may be locally melted) or partially locally melted (e.g, less than the entire target area is locally melted/only slight interface melting is provided before the SPR process). In some embodiments, the preheating system may be a welding system, including, but not limited to, a resistance spot welding system, which heats the metal substrates to at least partially melt the target location on the metal substrates and form a fusion region. The driver may be various suitable devices or mechanisms for driving the rivet into the target location. The rivet that is driven into the metal substrates may be any type of rivet as desired. During a SPR process, the preheating system may locally melt the target location (partially or entirely), and the driver drives the rivet into the target location before solidification of the target location.

In certain embodiments, the SPR systems and methods described herein may provide improved joints in metal substrates. In some embodiments, the SPR systems and methods provided herein may produce SPR joints having minimized on no cracking compared to joints formed without preheating. In certain embodiments, the rivet joints formed with the SPR systems and methods provided herein may have a reduced head height of the rivet compared to traditional joints and/or an improved minimum thickness without cracking compared to traditional joints. The SPR systems and methods described herein may also allow for joint formation in high-strength aluminum alloys that would otherwise not be possible or result in joints having various defects such as cracking. Various other benefits and advantages may be achieved using the SPR systems and methods described herein, and the aforementioned benefits and advantages should not be considered limiting.

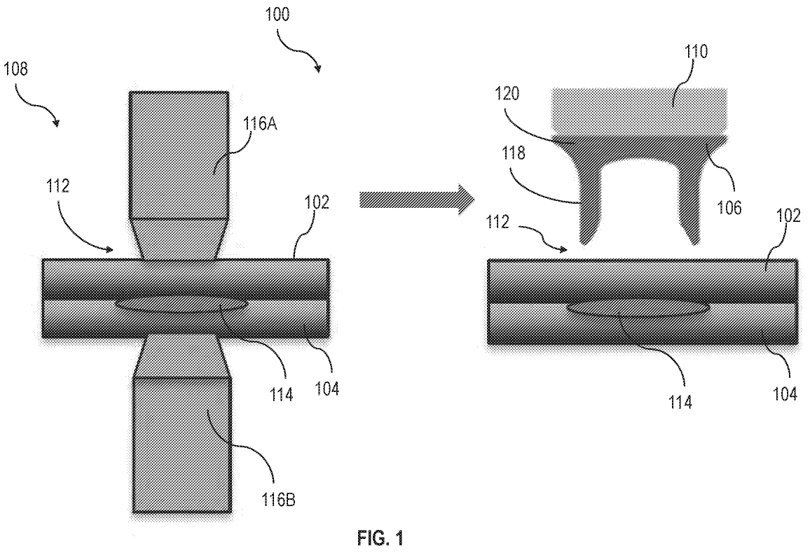

FIG. 1 illustrates an example of a SPR system 100 for joining at least a first substrate 102 to a second substrate 104 with a rivet 106.

While two substrates 102, 104 are illustrated, in other embodiments, any number of substrates may be joined as desired using the SPR system 100. In various examples, the substrates 102, 104 may be metal sheets, metal shates, or other suitable types of workpieces to form various parts or components of a final product. As used herein, a sheet generally refers to a metal (e.g., aluminum) product having a thickness of less than about 4 mm. For example, a sheet may have a thickness of less than 4 mm, less than 3 mm, less than 2 mm, less than 1 mm, less than 0.5 mm, less than 0.3 mm, or less than 0.1 mm. A shate (also referred to as a sheet plate) generally has a thickness of from about 4 mm to about 15 mm. For example, a shate may have a thickness of 4 mm, 5 mm, 6 mm, 7 mm, 8 mm, 9 mm, 10 mm, 11 mm, 12 mm, 13 mm, 14 mm, or 15 mm. In one non-limiting example, the substrates 102, 104 to be joined by the SPR system 100 may have a thickness of less than or equal to 5 mm, such as less than or equal to 3 mm, although they need not be in other embodiments.

In some examples, the first substrate 102 and/or the second substrate 104 may be selected from the group comprising a 1xxx aluminum alloy, a 2xxx aluminum alloy, a 3xxx aluminum alloy, a 4xxx aluminum alloy, a 5xxx aluminum alloy, a 6xxx aluminum alloy, a 7xxx aluminum alloy, or an 8xxx aluminum alloy. In some examples, the substrates 102, 104 may be different metals (e.g., the first substrate 102 is a 7xxx aluminum alloy and the second substrate 104 is a 6xxx series aluminum alloy). In other examples, the substrates 102, 104 are both the same series aluminum alloy (e.g., both the first and second aluminum alloys are a 7xxx aluminum alloy). In some non-limiting examples, one or more of the substrates 102, 104 may be a high-strength aluminum alloy, such as 2xxx aluminum alloys, 5xxx aluminum alloys, 6xxx aluminum alloys, and/or 7xxx aluminum alloys, among others. As discussed herein, whereas such high-strength aluminum alloys would experience cracking during a traditional SPR process, such cracking may be minimized and/or avoided using the SPR system 100.

In other examples, the substrates 102, 104 may be various other metals or materials to be welded together, including, but not limited to, aluminum, aluminum alloys, steel, steel-based materials, nickel, nickel-based materials, copper, copper-based materials, cast iron, titanium, titanium-based materials, various other suitable materials, and/or various combinations of materials. In other examples, the first metal sheet 102 and/or the second metal sheet 104 may include various other metals or types of metal sheets including, but not limited to, an aluminum cladded alloy sheet, a monolithic alloy (aluminum, steel, etc.), a roll bonded alloy, or various other types of metal sheets to be welded together.

As illustrated, the SPR system 100 includes a preheating system 108 and a driver 110 During a joining process, the preheating system 108 locally melts a target location 112 on the substrates 102, 104 to form a fusion or melted region 114 at the target location 112. The driver 110 then drives the rivet 106 into the target location 112 such that the rivet 106 pierces the substrates 102, 104 and thereby forms a joint.

The preheating system 108 may be various suitable devices or mechanisms for locally melting the target location 112. In certain embodiments, the preheating system 108 may heat the target location 112 for a melting duration and to a melting temperature. In some non-limiting examples, the melting duration may be less than 2 seconds, such as less than 1 second, such as less than or equal to 1000 milliseconds, such as less than or equal to 500 milliseconds In certain non-limiting examples, the melting duration is less than 500 milliseconds, such as less than or equal to 300 milliseconds. The melting temperature may be a temperature sufficient to at least partially melt (or make molten) a portion of the substrates 102, 104. In various non-limiting examples, the melting temperature may be at least 500° C., and in some optional embodiments the melting temperature may be at least 500° C. Optionally, a controller (not illustrated) may be communicatively coupled to the pre-heating system 108 to control the preheating system 108 such that the substrates 102, 104 are heated for the melting duration and to the melting temperature When included, the controller may be a general processing unit, a processor specially designed for joining applications, or other suitable processors or computing devices. The preheating system 108 that preheats the target location 112 for the melting duration and to the melting temperature may ensure that the substrates are locally melted at the target location 112 while minimizing delay in the overall joining process. The preheating system 108 optionally may allow for additional materials to be provided between the substrates 102, 104. As one non-limiting example, an adhesive optionally may be provided between the substrates 102, 104 or on opposing surfaces of the substrates 102, 104 at the target location to initially position the substrates 102, 104 relative to each other. In such embodiments, the adhesive need not be removed prior to pre-heating with the preheating system 108.

In the embodiment illustrated, the preheating system 108 is a resistance spot welding (RSW) system with electrodes 116A-B that are clamped together to contact opposing surfaces of the substrates 102, 104. While the electrodes 116A-B are clamped together, an electric current is applied via the electrodes 116A-B, and heat generated at the interface of the substrates 102, 104 causes the substrates 102, 104 to heat up and at least partially melt, thereby forming the fusion or melted region 114. Any number of electrodes 116A-B may be utilized as desired with the RSW system. In other embodiments, the preheating system 108 need not be a RSW system, and other types of welding systems and/or non-welding systems may be used as the preheating system 108 as desired.

The driver 110 may be various suitable devices or mechanisms for driving the rivet 106 into the target location 112 such that the rivet 106 pierces the substrates 102, 104 and thereby forms the joint. In various embodiments, the driver 110 drives the rivet 106 into the target location 112 while the target location 112 is at least partially melted and/or is not solidified. In such embodiments, the melted region 114 may facilitate insertion of the rivet 106 into the substrates 102, 104, particularly in high-strength substrates. In the embodiment illustrated, the driver 110 is a punch. Optionally, a die or guide may be included with the driver 110 to facilitate positioning and/or insertion of the rivet 106 into the substrates 102, 104 at the target location 112

The rivet 106 generally includes a base region 118 and a head 120, although the particular rivet 106 illustrated in FIG. 1 should not be considered limiting. During the joining process, the driver 110 drives the rivet 106 such that the rivet 106 pierces the first substrate 102 and at least partially engages the second substrate 104. The base region 118 may flare outwards or otherwise deform within the second substrate 104 to form a mechanical interlock, thereby forming the joint.

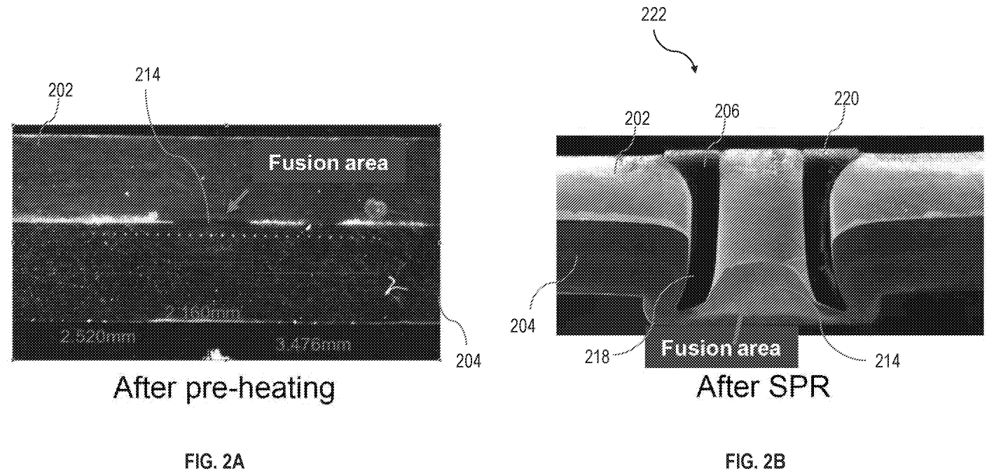

FIGS. 2A-B are sectional views of metal substrates 202, 204 during a joining process using the SPR system 100. In this embodiment, each of the metal substrates is a 7xxx aluminum alloy. As illustrated in FIG. 2A, after preheating with the preheating system 108, a fusion or melted region 214 is formed at the interface of the substrates 202, 204. Referring to FIG. 2B, after the riveting stage of the SPR process, a rivet 206 is driven through the melted region 214, thereby forming a joint 222 that joins the substrates 202, 204. Compared to the rivet 106, the rivet 206 is completely hollow. As illustrated in FIG. 2B, the joint 220 did not cause cracking in the substrates 202, 204.

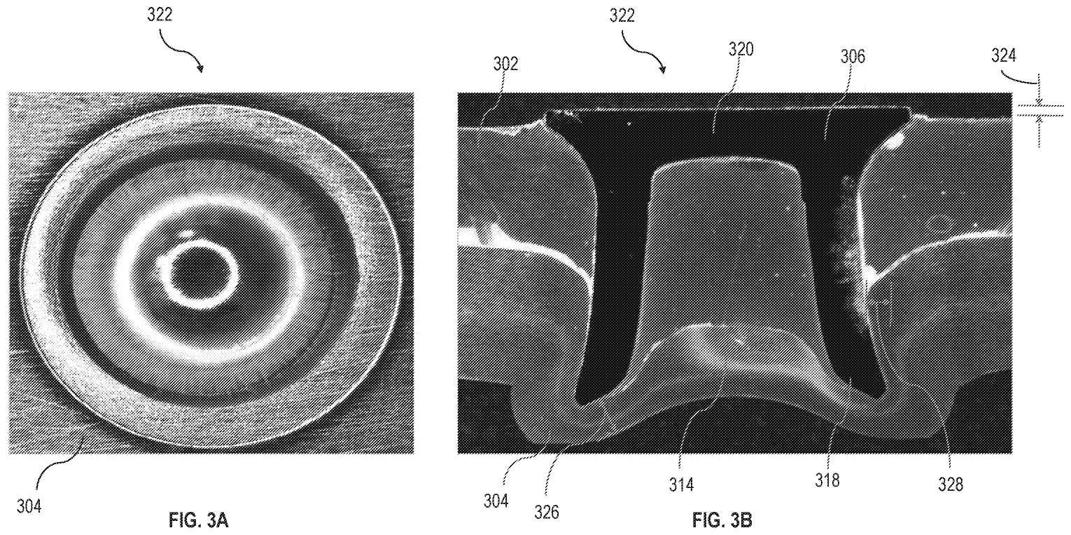

FIGS. 3A-B are photographs of another joint 322 formed using the SPR system 100 according to various embodiments and joining metal substrates 302, 304. In this embodiment, each metal substrate 302, 304 was the same 7xxx aluminum alloy, and each substrate had a thickness of 2.8 mm. As illustrated in FIG. 3A, which is a bottom view of the joint 322, and FIG. 3B, which is a sectional view, the joint 322 did not experience any cracking after a rivet 306 was driven through a fusion region 314.

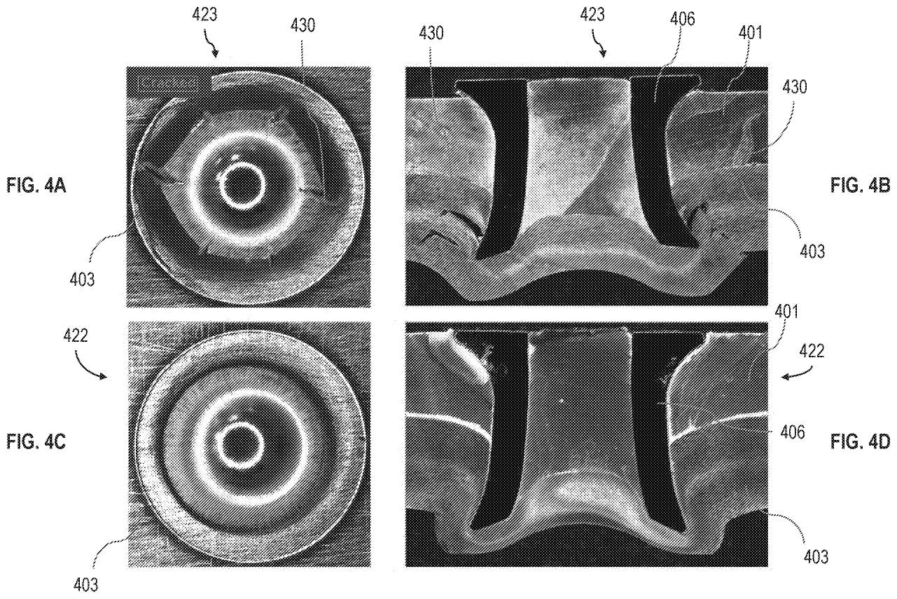

Referring to FIG. 3B, in certain embodiments, and as discussed in detail below, in addition to preventing or minimizing cracking compared to a traditional SPR process, a joint formed by the SPR system 100 described herein may have a reduced head height 324, reduced minimum thickness 326 without cracking, and/or improved interlock 328. As referred to herein, the head height 324 (HH) is an extent that a head 320 of the rivet 306 forming the joint 322 extends above or below the first substrate 302, the minimum thickness 326 (Tₘᵢₙ) is the minimum thickness of the second substrate 304 (which may be, but does not have to be, immediately adjacent to a base region 318 of the rivet 306), and the interlock 328 is an extent that the base region 318 of the rivet 306 flares or deforms outwards from the interface between the substrates 302, 304. The particular locations at which the head height 324, minimum thickness 326, and interlock 328 are illustrated as being measured from should not be considered limiting, and the lines for each measurement are for illustrative purposes and are not intended to be a particular measurement. Non-limiting examples of these improved measurements are described in detail below with reference to FIGS. 4A-D, SA-D, 6A-D, and 7A-D.

FIGS. 4A-D illustrate a non-limiting example of a comparison of a traditional SPR joint 423 (FIGS. 4A-B) and a SPR joint 422 (FIGS. 4C-D) formed using the SPR system 100. In this embodiment, both joints 422, 423 were formed in the same stack of metal substrates where the upper metal substrate 401 was a 6xxx aluminum alloy with a thickness of 2.5 mm, and the metal substrate 403 was a 7xxx aluminum alloy with a thickness of 2.8 mm. The same type of rivet 406 was used in both joints 422, 423. In this example, the traditional SPR joint 423 caused cracking 430 in the metal substrates 401, 403, while the SPR joint 422 did not cause cracking in the metal substrates 401, 403. In addition, the SPR joint 423 had a HH of 0.56 mm, a Tₘᵢₙ of 1 175 mm, and an interlock of 0.713 mm, while the SPR joint 422 had a HH of 0.01 mm, a Tₘᵢₙ of 0.602 mm, and an interlock of 0.658 mm. In this example, although the SPR joint 423 has a slightly increased interlock compared to the SPR joint 422, because the SPR joint 422 did not crack (unlike the joint 423), had a reduced HH, and had a reduced Tₘᵢₙ, the SPR joint 422 is the improved and better joint.

FIGS. SA-D illustrate another non-limiting example of a comparison of a traditional SPR joint 523 (FIGS. 5A-B) and a SPR joint 522 (FIGS. 5C-D) formed using the SPR system 100. In this embodiment, both joints 522, 523 were formed in the same stack of metal substrates where the metal substrate 501 was a 6xxx aluminum alloy with a thickness of 2.0 mm, and the metal substrate 503 was a 7xxx aluminum alloy with a thickness of 1.8 mm. The same type of rivet 506 was used in both joints 522, 523, and compared to the rivet 406, the rivet 506 is not completely hollow. In this example, the traditional SPR joint 523 caused cracking 530 in the metal substrates 501, 503. In contrast, the SPR joint 522 did not cause cracking in the metal substrates 501, 503. In addition, the SPR joint 523 had a HH of −0.02 mm, a Tₘᵢₙ of 0.533 mm, and an interlock of 0.16 mm, while the SPR joint 522 had a HH of −0.06 mm, a Tₘᵢₙ of 0.206 mm, and an interlock of 0.315 mm. From this information, the SPR joint 522 was the improved and better joint because it did not crack (unlike the joint S23), it had the lowest HH, it had the lowest Tₘᵢₙ, and it had the greatest interlock.

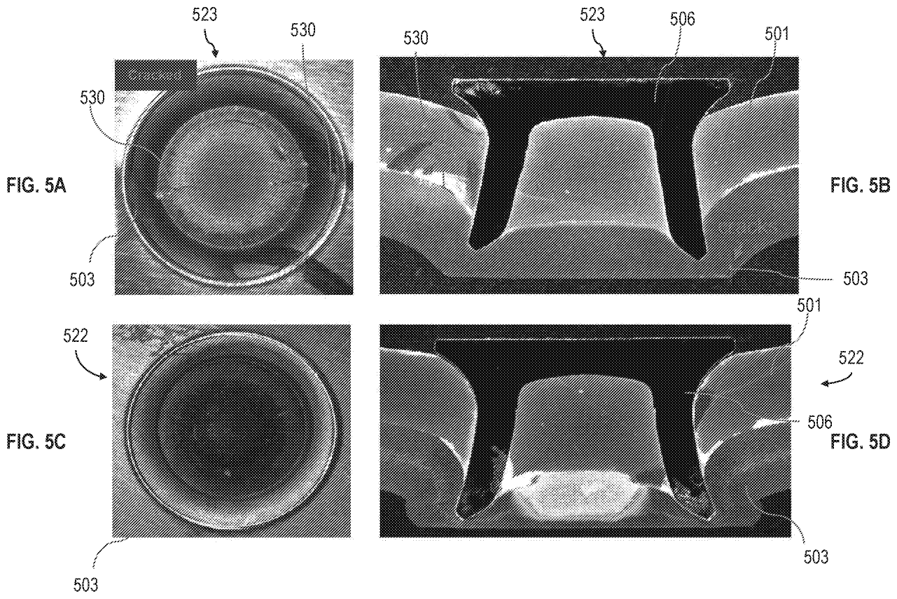

FIGS. 6A-D illustrate an additional non-limiting example of a comparison of a traditional SPR joint 623 (FIGS. 6A-B) and a SPR joint 622 (FIGS. 6C-D) formed using the SPR system 100. In this embodiment, both joints 622, 623 were formed in the same stack of metal substrates where the metal substrate 601 was a 6xxx aluminum alloy with a thickness of 2.5 mm the metal substrate 603 was a 7xxx aluminum alloy with a thickness of 2.8 mm. The same type of rivet 606 was used in both joints 622, 623, and similar to the rivet 406, the rivet 606 is hollow along its length. In this example, the traditional SPR joint 623 caused cracking 630 in the metal substrates 601, 603, but the SPR joint 622 did not cause cracking. In addition, the SPR joint 623 had a HH of 0.40 mm, a Tₘᵢₙ of 0.792 mm, and an interlock of 0.620 mm, while the SPR joint 622 had a HH of −0.06 mm, a Tₘᵢₙ of 0.485 mm, and an interlock of 0.602 mm. In this example, the SPR joint 622 was improved compared to the SPR joint 623. Based on these results, the SPR joint 622 was the improved and better joint because unlike the joint 623, the joint 622 did not cause cracking In addition, the Tₘᵢₙ was reduced in the SPR joint 622, and the negative HH (i.e., the head of the rivet 606 was recessed into the substrate 602) may be beneficial for further processing that requires minimal protrusions

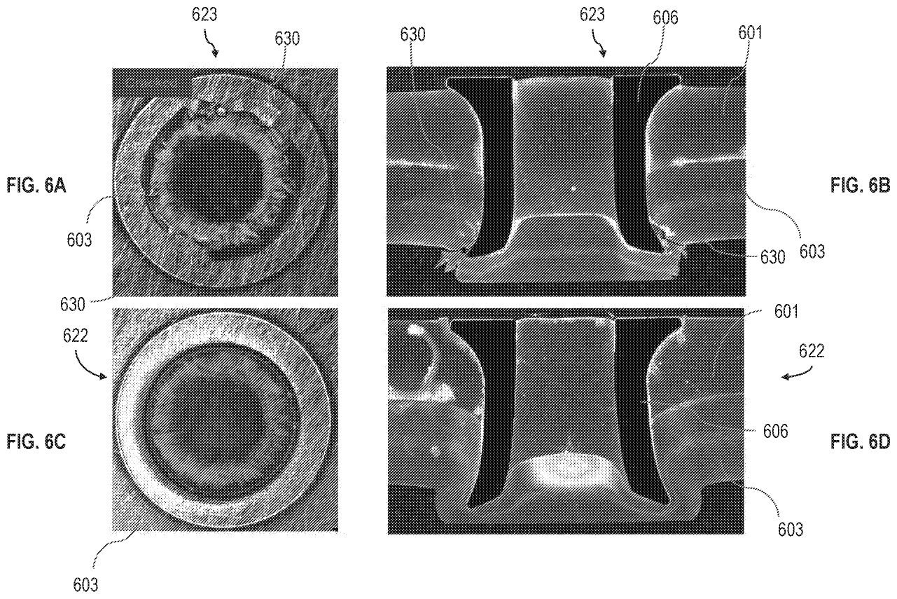

FIGS. 7A-D illustrate yet another non-limiting example of a comparison of a traditional SPR joint 723 (FIGS. 7A-B) and a SPR joint 722 (FIGS. 7C-D) formed using the SPR system 100. In this embodiment, both joints 722, 723 were formed in the same stack of metal substrates where the metal substrates 701 was a 6xxx aluminum alloys with a thickness of 2.5 mm and the metal substrate 703 was a 7xxx aluminum alloy with a thickness of 2.8 mm. The same type of rivet 706 was used in both joints 722, 723, and unlike the rivet 406, the rivet 706 is not hollow along its entire length. In this example, the traditional SPR joint 723 caused cracking 730 in the metal substrates 701, 703 while the SPR joint 722 did not. In addition, the SPR joint 723 had a HH of 0.36 mm, a Tₘᵢₙ of 0.784 mm, and an interlock of 0.603 mm, and the SPR joint 722 had a HH of −0.20 mm, a Tₘᵢₙ of 0.374 mm, and an interlock of 0.529 mm. From these results, the SPR joint 722 was the better and improved joint because it did not cause cracking (unlike the joint 723), and additionally because the SPR joint 722 had a reduced Tₘᵢₙ as well as a reduced (and negative) HH.

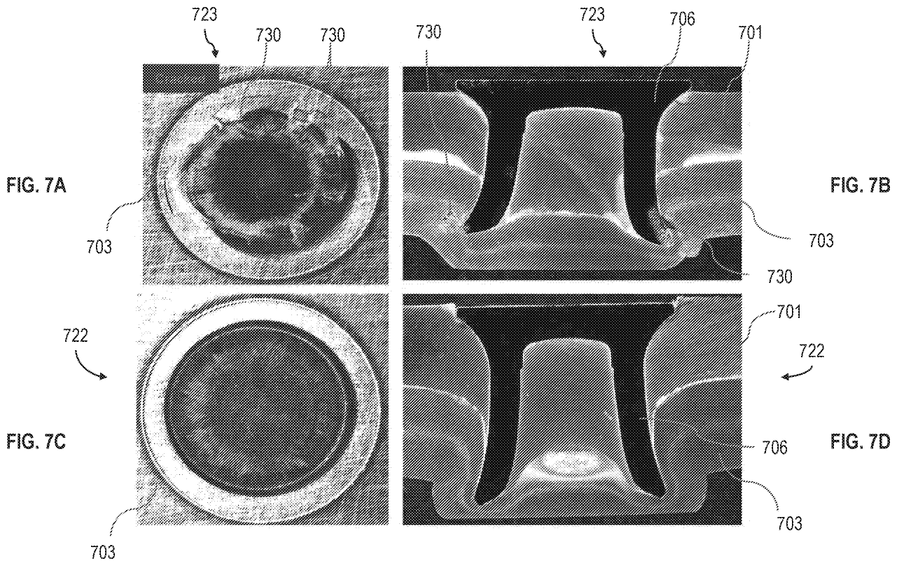

FIG. 8 illustrates additional examples of traditional SPR joints compared to SPR joints formed using the SPR system 100. As illustrated in FIG. 8, Material Stack 1 had an upper layer that was a 5xxx aluminum alloy with a thickness of 1.2 mm and a bottom layer that was a 7xxx aluminum alloy with a thickness of 1.8 mm. Material Stack 2 had an upper layer that was a 5xxx aluminum alloy with a thickness of 2.5 mm and a bottom layer that was a 7xxx aluminum alloy with a thickness of 1.8 mm. Both Material Stack 1 and Material Stack 2 were subjected to a traditional SPR process and a SPR process using the SPR system 100 using the same type of rivet. As illustrated, in both Material Stack 1 and Material Stack 2, during the traditional SPR process, the button of the joint cracked, the interlock was greater than 0.4 mm, and the SPR quality was not acceptable. In contrast, in both Material Stack 1 and Material Stack 2, during the SPR process using the SPR system 100, the button was not cracked, the interlock was greater than 0.4 mm, and the SPR quality was acceptable Based on these results, the SPR process using the SPR system 100 produced improved joints between the upper layer and bottom layer of both Material Stack 1 and Material Stack 2.

Referring back to FIGS. 1 and 2, a method of joining the first substrate 102 with the second substrate 104 with the SPR system 100 is also described. The method may include positioning the first substrate 102 and the second substrate 104 relative to each other such that the first substrate 102 and the second substrate 104 contact each other. In some embodiments, positioning the substrates 102, 104 may include using an adhesive between the substrates 102, 104 to facilitate positioning of the first substrate 102 relative to the second substrate 104. In some non-limiting examples, at least one of the substrates 102, 104 is a high-strength aluminum alloy. In one non-limiting example, at least one of the substrates 102, 104 is a 7xxx aluminum alloy and/or a 6xxx aluminum alloy.

The method includes preheating the first substrate 102 and the second substrate 104 at the target location 112 to locally melt the first substrate 102 and the second substrate 104 In some embodiments, preheating the substrates 102, 104 includes heating the substrates 102, 104 for a melting duration to a melting temperature. In certain aspects, heating the substrates 102, 104 includes heating the substrates 102, 104 for a melting duration of less than 2 seconds, such as less than or equal to 1000 milliseconds, such as less than 500 milliseconds, or such as less than 300 milliseconds. In various aspects, heating the substrates optionally includes heating the substrates 102, 104 to a melting temperature of at least 500° C. In some embodiments, preheating the substrates 102, 104 includes heating the substrates 102, 104 to locally melt the substrates 102, 104 at least at the interface between the substrates 102, 104. In various embodiments, heating the substrates 102, 104 includes heating the substrates with an RSW system, in which heating includes supplying a current to the electrodes 116A-B of the RSW system. In some optional examples, supplying the current to the electrodes 116A-B may include supplying a current from 10 kA to 22 kA. In one non-limiting example, preheating the substrates 102, 104 includes supplying the current to the electrodes 116A-B and heating the substrates 102, 104 for a melting duration of less than 1000 milliseconds and to a melting temperature of at least 500° C.

The method includes holding the substrates 102, 104, and driving the rivet 106 with the driver 110 such that the rivet 106 pierces through the first substrate 102 at the target location 112. In various embodiments, the rivet 106 is driven into target location 112 before the melted region 114 (formed in the preheating step) solidifies. In this step, the rivet 106 at least partially pierces the second substrate 104 and the base 118 flares or otherwise deforms within the second substrate 104.

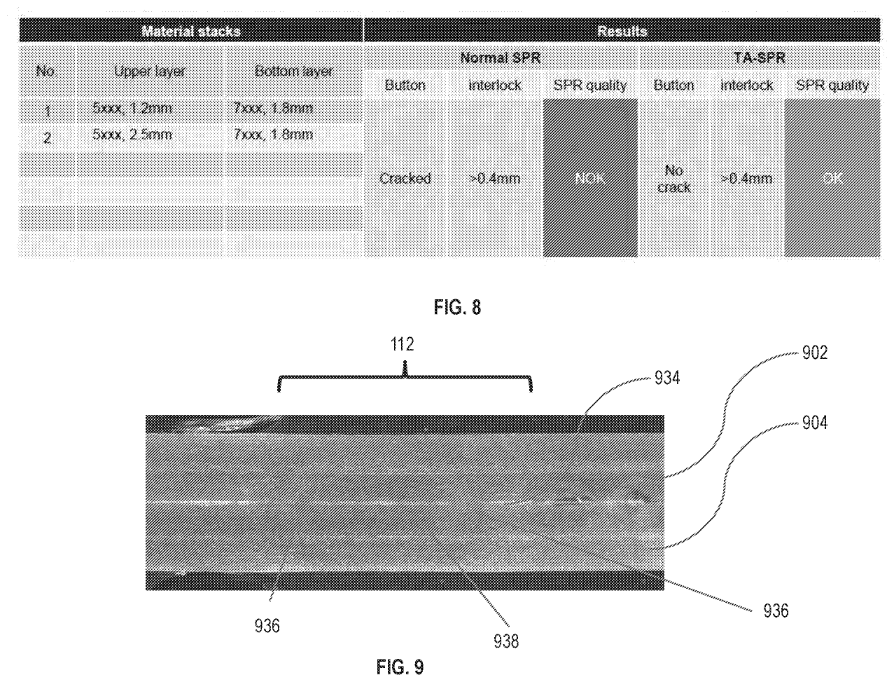

FIG. 9 is a sectional views of metal substrates 902, 904 during a joining process using the SPR system 100 after pre-heating and before a SPR process. In this embodiment, each of the metal substrates is a 7xxx aluminum alloy. In the embodiment of FIG. 9, the metal substrates 902, 904 form the target location 112. In certain embodiments, and as illustrated in FIG. 9, an interface 934 of the metal substrates 902, 904 at the target location 112 is partially locally melted (e.g., the interface 934 includes melted portions 936 and non-melted portions 938). In some embodiments, the partially locally melted interface 934 may be achieved by controlling the heat applied during the preheating with the preheating system. In other embodiments, the entire interface 934 may be locally melted.

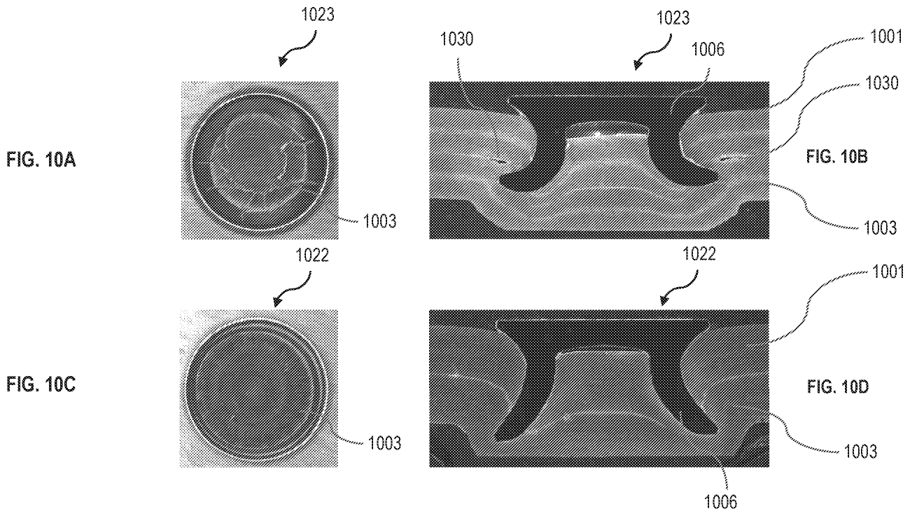

FIGS. 10A-D illustrate yet another non-limiting example of a comparison of a traditional SPR joint 1023 (FIGS. 10A-B) and a SPR joint 1022 (FIGS. 10C-D) formed using the SPR system 100. In this embodiment, both joints 1022, 1023 were formed in the same stack of metal substrates where the metal substrates 1001 was a 7xxx aluminum alloys with a thickness of 1.8 mm and the metal substrate 1003 was a 7xxx aluminum alloy with a thickness of 1.8 mm. The same type of rivet 1006 was used in both joints 1022, 1023. The interface of the target region of the SPR joint 1022 was partially locally melted during preheating. In this example, the traditional SPR joint 1023 caused cracking 1030 in the metal substrates 1001, 1003 while the SPR joint 1022 did not. In addition, the SPR joint 1023 had a HH of 0.35 mm, a Tₘᵢₙ of 0.559 mm, and an interlock of 0.621 mm, and the SPR joint 1022 had a HH of 0.02 mm, a Tₘᵢₙ of 1 302 mm, and an interlock of 0.839 mm. From these results, the SPR joint 1022 was the better and improved joint because it did not cause cracking (unlike the joint 1023), and additionally because the SPR joint 1022 had a reduced HH and increased interlock. As illustrated in FIG. 10D, the interface of the metal substrates 1002, 1003 at the target location was clear with slight melting observed, thereby illustrating that a complete local melting of the interface of the target location is not required to provide an improved SPR joint according to embodiments.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A self-piercing riveting system comprising: a localized melting system configured to locally melt a target location on a metal substrate; and a driver configured to drive a rivet into the metal substrate at the target location after the target location is locally melted to form a joint.

Illustration 2. The self-piercing riveting system of any preceding or subsequent illustrations or combination of illustrations, wherein the localized melting system comprises a resistance spot welding system.

Illustration 3. The self-piercing riveting system of any preceding or subsequent illustrations or combination of illustrations, wherein the localized melting system is configured to heat the target location for a duration of less than 1 second and to a temperature of at least 500° C.

Illustration 4. The self-piercing riveting system of any preceding or subsequent illustrations or combination of illustrations, further comprising a controller communicatively coupled to the localized melting system and the driver, wherein the controller is configured to control the localized melting system to apply heat for a melting duration to a melting temperature.

Illustration 5. The self-piercing riveting system of any preceding or subsequent illustrations or combination of illustrations, wherein the melting duration is greater than 0 seconds and less than or equal to 1000 milliseconds, and wherein the melting temperature is at least 500° C.

Illustration 6. The self-piercing riveting system of any preceding or subsequent illustrations or combination of illustrations, wherein the self-piercing riveting system is configured to form the joint in the metal substrate comprising a 7xxx aluminum alloy with a thickness of less than 5 mm.

Illustration 7. A method of joining at least two metal substrates, the method comprising, locally melting a target location on the at least two metal substrates; and driving a rivet into the target location with a driver after locally melting the target location such that the rivet pierces the at least two metal substrates at the target location.

Illustration 8. The method of any preceding or subsequent illustrations or combination of illustrations, wherein at least one of the two metal substrates comprises a 7xxx aluminum alloy.

Illustration 9. The method of any preceding or subsequent illustrations or combination of illustrations, wherein each of the at least two metal substrates comprises a thickness of less than or equal to 5 mm.

Illustration 10. The method of any preceding or subsequent illustrations or combination of illustrations, wherein locally melting the target location comprises welding the target location with a resistance spot welding system for a melting duration and to a melting temperature.

Illustration 11. The method of any preceding or subsequent illustrations or combination of illustrations, wherein the melting duration is from greater than 0 seconds to less than 1 second.

Illustration 12. The method of any preceding or subsequent illustrations or combination of illustrations, wherein the melting duration is from greater than 0 seconds to less than or equal to 1000 milliseconds.

Illustration 13. The method of any preceding or subsequent illustrations or combination of illustrations, wherein the melting temperature is at least 500° C.

Illustration 14. The method of any preceding or subsequent illustrations or combination of illustrations, wherein driving the rivet into the target location with the driver after locally melting the target location comprises driving the rivet into the target location before solidification of the target location.

Illustration 15. A joint formed by the method of any preceding or subsequent illustrations or combination of illustrations.

Illustration 16. A method of joining at least two metal substrates, the method comprising: welding the at least two substrates at a target location for a welding time of greater than 0 seconds and less than 1 second and such that a temperature of the target location is at least 500° C.; and driving a rivet into the target location after welding such that the rivet pierces the at least two metal substrates at the target location.

Illustration 17. The method of any preceding or subsequent illustrations or combination of illustrations, wherein at least one of the two metal substrates comprises a 7xxx aluminum alloy.

Illustration 18. The method of any preceding or subsequent illustrations or combination of illustrations, wherein each of the at least two metal substrates comprises a thickness of less than or equal to 5 mm.

Illustration 19. The method of any preceding or subsequent illustrations or combination of illustrations, wherein the welding time is from greater than 0 seconds to less than or equal to 1000 milliseconds.

Illustration 20. The method of any preceding or subsequent illustrations or combination of illustrations, wherein driving the rivet into the target location after welding the target location comprises driving the rivet with a driver into the target location before solidification of the target location.

Illustration 21. The method of any preceding or subsequent illustrations or combination of illustrations, further comprising applying an adhesive between the at least two metal substrates at the target location prior to welding.

Illustration 22. A joint formed by the method of any preceding or subsequent illustrations or combination of illustrations.

Illustration 23. The method of any preceding or subsequent illustrations or combination of illustrations, wherein locally melting the target region and/or welding the target region comprises partially locally melting an interface of the metal substrates at the target region.

Illustration 23. The method of any preceding or subsequent illustrations or combination of illustrations, wherein locally melting the target region and/or welding the target region comprises locally melting an entirety of an interface of the metal substrates at the target region.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements.

Aspects and features of the present disclosure can be used with any suitable metal substrate including, but not limited to, aluminum, aluminum alloys, steel, steel-based materials, nickel, nickel-based materials, copper, copper-based materials, cast iron, titanium, titanium-based materials, aluminum cladded alloys, a monolithic alloy, a roll bonded alloy, and/or various other metals or combinations of metals. Aspects and features of the present disclosure may be especially useful for bonding aluminum and/or aluminum alloys In this description, reference is made to alloys identified by aluminum industry designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

1. A self-piercing riveting system comprising:
a localized melting system configured to locally melt a target location on a metal substrate; and
a driver configured to drive a rivet into the metal substrate at the target location, after the target location is locally melted, to form a joint.

2. The self-piercing riveting system of claim 1, wherein the localized melting system comprises a resistance spot welding system.

3. The self-piercing riveting system of claim 1, wherein the localized melting system is configured to heat the target location for a duration of less than 1 second and to a temperature of at least 500° C.

4. The self-piercing riveting system of claim 1, further comprising a controller communicatively coupled to the localized melting system and the driver, wherein the controller is configured to control the localized melting system to apply heat for a melting duration to a melting temperature.

5. The self-piercing riveting system of claim 4, wherein the melting duration is greater than 0 seconds and less than or equal to 1000 milliseconds, and wherein the melting temperature is at least 500° C.

6. The self-piercing riveting system of claim 1, wherein the self-piercing riveting system is configured to form the joint in the metal substrate, wherein the metal substrate comprises a 7xxx aluminum alloy with a thickness of less than 5 mm.

7. A method of joining at least two metal substrates, the method comprising:
locally melting a target location on the at least two metal substrates; and
driving a rivet into the target location with a driver after locally melting the target location such that the rivet pierces the at least two metal substrates at the target location.

8. The method of claim 7, wherein at least one of the two metal substrates comprises a 7xxx aluminum alloy.

9. The method of claim 7, wherein each of the at least two metal substrates comprises a thickness of less than or equal to 5 mm.

10. The method of claim 7, wherein locally melting the target location comprises welding the target location with a resistance spot welding system for a melting duration and to a melting temperature.

11. The method of claim 10, wherein the melting duration is from greater than 0 seconds to less than 1 second.

12. The method of claim 10, wherein the melting duration is from greater than 0 seconds to less than or equal to 1000 milliseconds.

13. The method of claim 10, wherein the melting temperature is at least 500° C.

14. The method of claim 7, wherein driving the rivet into the target location with the driver after locally melting the target location comprises driving the rivet into the target location before solidification of the target location.

15. (canceled)

16. A method of joining at least two metal substrates, the method comprising:
welding the at least two metal substrates at a target location for a welding time of greater than 0 seconds and less than 1 second and such that a temperature of the target location is at least 500° C.; and
driving a rivet into the target location after welding such that the rivet pierces the at least two metal substrates at the target location.

17. The method of claim 16, wherein at least one of the two metal substrates comprises a 7xxx aluminum alloy.

18. The method of claim 16, wherein each of the at least two metal substrates comprises a thickness of less than or equal to 5 mm.

19. The method of claim 16, wherein the welding time is from greater than 0 seconds to less than or equal to 1000 milliseconds.

20. The method of claim 16, wherein driving the rivet into the target location after welding the target location comprises driving the rivet with a driver into the target location before solidification of the target location.

21. The method of claim 16, further comprising applying an adhesive between the at least two metal substrates at the target location prior to welding.

22. (canceled)
